(19) United States
(12) Patent Application Publication
(10) Pub. No.: US 2010/0021696 A1
(43) Pub. Date: Jan. 28, 2010

(54) METHOD FOR MANUFACTURING A HYGIENE PRODUCT, APPARATUS FOR MANUFACTURING A HYGIENE PRODUCT AND HYGIENE PRODUCT

(75) Inventors: Walter Hill, Lampertheim (DE); Thomas Heilemann, Frankenthal (DE); Joachim Leonhardt, Mannheim (DE); Harald Harlacher, Mannheim (DE); Ferdinand Hein, Mannheim (DE)

Correspondence Address: YOUNG & THOMPSON, 209 Madison Street, Suite 500, Alexandria, VA, 22314, US

(73) Assignee: SCA HYGIENE PRODUCTS GMBH, Mannheim (DE)

(21) Appl. No.: 12/515,835

(22) PCT Filed: Dec. 13, 2006
(86) PCT No.: PCT/EP2006/011989

§ 371 Date: May 21, 2009

(51) Int. Cl. B32B 3/30; B31F 1/07

(52) U.S. Cl. 428/187; 156/209; 156/536

(57) ABSTRACT

A method of manufacturing a hygiene product, includes the steps of providing at least a first web (1) and a second web (2), pre-treating the first web and/or the second web, embossing the first web with a décor embossing pattern in a first décor embossing zone (38) having a décor embossing roll (34), and laminating together the first web and the second web in a lamination zone (30), the lamination zone being defined between the décor embossing roll and a lamination roll (36), wherein the décor embossing roll and the lamination roll have a generally-equal surface hardness.

### TECHNICAL FIELD

The present invention relates to a method for manufacturing a hygiene product, an apparatus for carrying out the method and a multi-ply hygiene product.

Hygiene products in the following primarily include all kinds of dry-creped tissue paper, wet-creped tissue paper and cellulose pulp wadding or all kinds of nonwovens, or combinations, laminates or mixtures thereof. Some of these hygiene products are also referred to as wiping products. Typical properties of these hygiene products include the ready ability to absorb tensile stress energy, their drapability, good textile-like flexibility, properties which are frequently referred to as bulk softness, a high surface softness, and a high specific volume with a perceptible thickness. As high a liquid absorbency as possible and, depending on the application, a suitable wet and dry strength as well as an appealable visual appearance of the outer product surface is desired. These properties, among others, allow these hygiene products to be used, for example, as sanitary products such as for example toilet paper, paper or non-woven handkerchiefs, household towels, towels, and the like; as cosmetic wipes such as for example facials and as serviettes or napkins; as cleaning wipes such as paper or non-woven wipes, windscreen cleaning wipes, industrial wipes, kitchen paper, or the like, just to mention some of the possible wide range of products that can be manufactured in this manner. Furthermore, the hygiene products can be dry, moist, wet or pre-treated in any manner. In addition, the hygiene and wiping products may be folded, interleaved or individually placed, stacked or rolled, connected or not, in any suitable manner. The products can be used for personal and household use as well as for commercial, away-from-home and industrial use. They are adapted to absorb fluids, for décorative purposes, for packaging or even just as supporting material, as is common for example in medical practices or in hospitals. In terms of their wide variety, hygiene products and wiping products are now considered to be everyday products.

Especially for the present invention toilet paper or kitchen towels or wipes are concerned, which are wound to rolls by a continuous paper web, wherein sheets are partly separated by perforation lines. These hygiene products may be made of single or multi-ply tissue paper or non-woven or a combination of tissue paper and non-woven.

Tissue paper is defined as a soft absorbent paper having a low basis weight. One generally selects a basis weight of 8 to 30 g/m², especially 10 to 25 g/m² per ply. The total basis weight of multiple-ply tissue products is preferably equal to a maximum of 80 g/m², preferably to a maximum of 70 g/m², and more preferably to a maximum of 65 g/m². Its density is typically below 0.6 g/cm³, preferably below 0.30 g/cm³ and more preferably between 0.08 and 0.20 g/cm³. The production of tissue is distinguished from paper production by its extremely low basis weight and its much higher tensile energy absorption index (see DIN EN 12625-4 and DIN EN 12625-5). Paper and tissue paper also differ in general with regard to the modulus of elasticity that characterizes the stress-strain properties of these planar products as a material parameter.

A tissue's high tensile energy absorption index results from a creping process which can result in an outer or an inner creping. The former is produced by compression of the paper web adhering to a dry cylinder as a result of the action of a crepe doctor. The latter is produced as a result of a difference in speed between, e.g. two forming wires (“fabrics”) which causes the still moist, plastically deformable paper web to be internally broken up by compression and shearing, thereby rendering it more stretchable under load than an uncreped paper.

Moist tissue paper webs are usually dried by the so-called Yankee drying, the through air drying (TAD) or the impulse drying method.

The fibres contained in the tissue paper are mainly cellulose fibres, such as pulp fibres from chemical pulp (e.g. Kraft sulfite and sulfate pulps), mechanical pulp (e.g. ground wood), thermo mechanical pulp, chemo-mechanical pulp, chemo-thermo mechanical pulp (CTMP) and/or high-temperature CTMP (HCTMP). Pulps derived from deciduous (hardwood), coniferous (softwood) and/or annual plants (e.g. straw) can be used. The fibres may also be or include recycled fibres, which may contain any or all of the above categories. The fibres can be treated with additives—such as fillers, softeners, such as quaternary ammonium compounds, binders, conventional dry-strength agents or wet-strength agents used to facilitate the original paper making or to adjust the properties thereof. The tissue paper may also contain other types of fibres, e.g. regenerated cellulose fibres or synthetic fibres enhancing, for instance, strength, absorption, smoothness or softness of the paper.

Tissue paper may be converted to the final hygiene product in many ways, for example, by embossing or laminating multiple tissue plies into a multi-ply product, rolled or folded.

If tissue paper is to be made out of pulp, the process essentially comprises

a) providing a suspension of cellulose fibres and water,

b) forming in the headbox and on a forming wire section, to provide an endless single ply wet web,

c) drying the wet web in a pre-drying section (TAD (through air drying) and/or conventional drying on the Yankee cylinder) that also usually includes the crepe process essential for the manufacture of tissues, to provide an endless single ply dry tissue ply,

d) typically the monitoring and winding section.

A wet fibrous web can be formed in step b) by placing the cellulose fibres, in an oriented or random manner, on one or between two continuously revolving forming wires of a paper making machine while simultaneously removing the main quantity of water of dilution until dry-solids contents of usually between 12% and 35% are obtained.

Drying the formed primary fibrous web occurs in one or more steps by mechanical and thermal means until a final dry-solids content of usually about 93% to 97%. In the case of tissue making, this stage is followed by the crepe process which crucially influences the properties of the finished tissue product in conventional processes. The conventional dry crepe process involves creping on a usually 4.5 to 6 m diameter drying cylinder, the so-called Yankee cylinder, by means of a crepe doctor with the aforementioned final dry-solids content of the raw tissue paper (wet creping can be used if lower demands are required for the tissue quality). The creped, finally dry raw tissue paper (raw tissue) is then available for further processing into the paper product or tissue paper product according to the invention.

Instead of the conventional tissue making process described above, a modified technique can be used in which an improvement in specific volume is achieved by a special kind of pre-drying within process section c) and in this way an improvement in the bulk softness of the thus made tissue paper is achieved. This process, which exists in a variety of subtypes, is termed the TAD (through air drying) technique. It is characterized by the fact that the “primary” fibrous web that leaves the sheet making stage is pre-dried to a dry-solids content of about 80% before final contact drying on the Yankee cylinder by blowing hot air through the fibrous web. The fibrous web is supported by an air-permeable fabric or belt and during its transport is guided over the surface of an air-permeable rotating cylinder drum. Structuring the supporting fabric or belt makes it possible to produce any pattern of compressed zones broken up by deformation in the moist state, resulting in increased mean specific volumes and consequently leading to an increase in bulk softness without decisively decreasing the strength of the fibrous web.

When applying the through air drying (TAD) technique for the production of raw tissue and the usual double-screen sheet formation in c-wrap configuration, for example, the so-called inner sheet-forming screen can thus be operated at a speed that is up to 40% faster than that of the next fabric or that of the subsequent felt, the initially formed and already pre-drained paper web being transferred to the next TAD fabric. This causes the still moist and as a result plastically deformable paper web to be internally broken up by compression and shearing, thereby rendering it more stretchable under load than a paper that has undergone neither “internal” nor external creping.

Another possible influence on the softness and strength of the raw tissue lies in the production of a layering in which the primary fibrous web to be formed is built up by a specially constructed headbox in the form of physically different layers of fibrous material, these layers being jointly supplied as a pulp strand to the sheet making stage.

To produce multi-ply tissue paper hygiene products, such as handkerchiefs, toilet paper, towels or kitchen towels, an intermediate step preferably occurs with so-called doubling in which the raw tissue in the finished product's desired number of plies is usually gathered on a common multiply master roll.

Paper and tissue paper also differ in general with regard to the modulus of elasticity that characterizes the stress-strain properties of these planar products as a material parameter, depending on the production conditions, raw materials used and chemical additives.

The term non-woven (ISO 9092, DIN EN 29092) is applied to a wide range of products which, in terms of their properties, are located between those of paper (cf. DIN 6730, May 1996) and cardboard (DIN 6730) on the one hand, and textiles on the other hand. As regards non-woven a large number of extremely varied production processes are used, such as the air-laid and spun-laced techniques as well as wet-laid techniques. The non-woven includes mats, non-woven fabrics and finished products made thereof. Non-wovens may also be called textile-like composite materials, which represent flexible porous fabrics that are not produced by the classic methods of weaving warp and weft or by looping. In fact, non-wovens are produced by intertwining, cohesive or adhesive bonding of fibres, or a combination thereof.

The non-woven material can be formed of natural fibres, such as cellulose or cotton fibres, but can also consist of synthetic fibres, such as polyethylene (PE), polypropylene (PP), polyurethane (PU), polyester, polyamide (PA) or regenerated cellulose, or a mix of different fibres. The fibres may, for example, be present in the form of endless fibres of pre-fabricated fibres of a definite length, as synthetic fibres produced in situ, or in the form of staple fibres. The nonwovens may thus consist of mixtures of synthetic and cellulose fibrous material, e.g. natural vegetable fibres (see ISO 9092, DIN EN 29092).

The plies of tissue paper used for the manufacture of hygiene products can be made from known tissue paper types used for this purpose. The hygiene product (also known as multiple-ply hygiene product) has one or preferably more tissue plies whereof each ply may consist of several layers.

After the web has been dried, lotion application and/or additive application can take place. A suitable point in time is, for example, directly after drying the web, shortly before combining the webs to form hygiene products or before forming the multi-ply web into the final hygiene product.

However, it is preferred first to laminate at least two single ply webs to a multi-ply web, followed by the application of lotion. For hygiene products having two or more tissue plies, the lotion composition may be applied to each outer ply or only to the outer side of one or both outer plies.

In a preferred production process for lotioned 4-ply hygiene products, two 2-ply webs are each lotioned on one side only, followed by joining together the untreated sides of the 2-ply webs to obtain a 4-ply product, in particular a 4-ply lotioned toilet paper product. It is preferred to apply the lotion composition to at least one, preferably both outer sides of the outer plies of multi-ply tissue webs, since then the advantageous penetration behavior of a low viscosity lotion composition can fully be developed by achieving a distribution as even as possible with respect to the z-direction (perpendicular) of the tissue paper.

The individual plies or the multi-ply structure may be laminated and/or embossed with micro embossings or macro embossings either before or after application of the lotion composition. Suitable application techniques include spraying, rotogravure printing or flexographic printing or application by means of rolls having a smooth surface. Preferably, the lotion composition is slightly heated, in particular to a temperature of 30° to 50° C., in particular 32° to 38° C. before it is applied to the web. Preferably, the lotion is applied in an amount of 0.1 to 20 g, in particular 0.5 to 10 g and preferably in an amount of 1.0 to 5 g per m² treated surface, i.e. with the double the amount, if both surfaces are lotioned. The weight ratio lotion composition/web (single or multi-ply, dry weight) is preferably 3 to 30% more preferably 5 to 20% by weight.

### DESCRIPTION OF THE PRIOR ART

In multi-ply hygiene products, the plies can be structured by different methods. One of those methods is to structure the plies by surface embossing using single zone or multi-zone embossing. The ply bonding of the single plies is then usually provided by using an adhesive.

Such a bonding or combination of several plies, typically tissue plies, can be performed by several techniques, e.g. by a so called “goffra incolla” process. In this process, the plies that are to be bonded together are fed through a “marrying zone” which is formed by a steel roll that carries décor embossing protrusions for embossing a décor embossing pattern into some of the plies, and a marrying roll which has a surface that is made from an elastic material, such as a rubber material. In the marrying zone, the plies are bonded together. The surface hardness of the marrying roll is typically in the range of 75 to 100 Shore A. In the goffra incolla process, the décor protrusions that are provided on the surface of the steel roll are, in a first décor embossing zone, embossed into a first set of plies that are to be bonded together. The first décor embossing zone is formed by the steel roll of the goffra incolla unit and a counter roll that carries an elastic surface. The first décor embossing zone is separate from the marrying zone, although both are formed using the steel roll which carries the décor protrusions.

The plies are thus fed through a first zone between the steel roll carrying the décor protrusions and the counter roll and are then transported via the steel roll to the marrying zone comprised of the steel roll carrying the décor protrusions and the elastic marrying roll. The second set of plies that are to be bonded to first set of plies is as well transported to the marrying zone and fed through the marrying zone together with the first set of plies. Before the first set of plies is fed through the marrying zone, an adhesive is coated to the summit regions of the décor embossing pattern of the respective outer ply that is transported by the steel roll. Consequently, the adhesive comes into contact with the second set of plies in the marrying zone.

The pressure exerted onto the plies to be bonded together in the marrying zone can be adjusted by a variation of the distance of the marrying roll with respect to the steel roll. This bonding pressure is to be set such that, on the one hand, it is ensured that the plies are reliably bonded together but, on the other hand, it is also desired to adjust the pressure such that the second set of plies do not receive the décor pattern that is situated on the surface of the steel roll when passing through the marrying zone. In other words, it is difficult to adjust the correct pressure in the marrying zone. Often, embossing accuracy of the lower side of the finished product is sacrificed for the reliability of the bonding process. In other words, the product that comes out of the marrying zone of a goffra incolla unit often exhibits an accurate décor pattern on the upper side but shows a through-embossing of the décor pattern on the lower side of the finished hygiene product. The hygiene product, thus, shows a two-sidedness such that the décor pattern for the upper side of the product is, unintentionally, also embossed through to the lower side of the hygiene product.

U.S. Pat. No. 4,376,671 discloses a multi-ply fibrous web structure and its manufacture, wherein a pair of embossing rolls made of substantially rigid materials, such as steel, are provided with aligned patterns of identical embossing protuberances. The embossing rolls include protuberances for a décor pattern as well as protuberances of a lesser height of a microstructure embossing pattern. In order to change the microstructure embossing pattern or the décor embossing pattern, a new set of rolls has to be provided. Furthermore, the volume of the resulting multi-ply tissue product cannot be influenced by adjusting the embossing patterns.

International patent publication WO 93/12293 discloses a complex sheet of absorbent tissue paper consisting of two or more sheets of crepe tissue paper having a first embossed pattern and a second embossed pattern. The tissue paper product is made by passing the crepe tissue paper through an embossing nip between a pair of steel rolls that have a décor embossing pattern with décor embossing protrusions and a microstructure embossing pattern with microstructure embossing protrusions that have a lesser height than the height of the décor embossing protrusions.

General goals with respect to hygiene products are to provide softness, an improved feeling, good mechanical strength and the desired absorption properties in the final hygiene product. It is, furthermore, desired to improve the optical appearance of such hygiene products, in particular with regard to imprinted embossings, more particular décor embossings. It is desired to provide a hygiene product which has an improved and defined optical and haptic appearance on both of its sides, with sharpness of the edges of the décor embossings. In this regard, an identical optical appearance on both sides of the resulting hygiene product or, in a different embodiment, independent optical appearances on the respective sides of the hygiene product in a defined manner are desirable in order to meet the customers' expectations as to high quality hygiene products.

### SUMMARY OF THE INVENTION

It is an object of the invention to improve the optical and haptic appearance of a hygiene product, in particular the optical and haptic appearance of the lower side of the hygiene product in order to reduce an optical and haptic two-sidedness of the manufactured hygiene product.

This object is solved by a method of manufacturing a hygiene product with the features of claim 1 or the features of claim 33. An apparatus for carrying out the method is claimed in claim 64. A multi-ply hygiene product is defined in claim 75.

The method according to the invention resides in providing at least a first web and a second web, pre-treating the first web and/or the second web, and embossing the first web with a décor embossing pattern in a first décor embossing zone comprising a décor embossing roll. As a further step, the method comprises laminating together the first web and the second web in a lamination zone, the lamination zone being defined between said décor embossing roll and a laminating roll, wherein the décor embossing roll and the laminating roll have a generally equal surface hardness.

The inventive method has the advantage of providing, on the one hand, a finished hygiene product that is laminated from at least two webs that show an accurately embossed décor pattern on the upper side/outer side of the finished hygiene product but, on the other hand, significantly reduces, or even avoids, a through-embossing of the lower side/inner side of the finished hygiene product by using a laminating roll of the same surface hardness as that of the décor embossing roll. In other words, since the décor embossing roll and the laminating roll exhibit the same surface hardness, there is no elastic deformation of the laminating roll which would, consequently, lead to a through-embossing of the décor pattern onto the lower side of the finished hygiene product. Accordingly, a two-sidedness of the décor embossing pattern can be reduced or even avoided. This considerably improves the optical and haptic perception of a finished hygiene product, in particular that of the lower side (or: inner side, when on a roll) of the hygiene product. Additionally, by pre-treating at least the first web and/or the second web, the finished hygiene product can be adjusted to additionally improve the optical and haptic appearance of the finished hygiene product.

The terms “microstructure (embossing) pattern” and “macrostructure (embossing) pattern” that are used throughout the description are conventionally also referred to as a “background embossing pattern”. The term “décor (embossing) pattern” is conventionally also referred to as a “design pattern”. It is important to note that the terms “microstructure pattern”, “macrostructure pattern” and “décor pattern” are to be seen in relative terms such that the microstructure pattern usually comprises protrusions that are smaller than the protrusions of the macrostructure pattern and of the décor pattern. Typically, the microstructure pattern also exhibits a higher protrusion density than that of the macrostructure pattern and the décor pattern. The décor pattern protrusions usually show some décor elements such as feathers, flowers (e.g. camomile or roses) or other structures that can be clearly identified by the user, whereas the macrostructure pattern is usually rather uniform and may comprise protrusion dots or a waffle pattern. The décor elements and the macrostructure pattern are usually visible, whereas the microstructure pattern is not necessarily immediately visible. However, the microstructure pattern can be hapticly experienced since the embossed web has a softer feel.

According to an alternative of the invention, the method of manufacturing a hygiene product comprises the steps of providing at least a first web and a second web, embossing the first web with a décor embossing pattern in a first décor embossing zone comprising a décor embossing roll. As a further step, the first web and the second web are laminated together in a lamination zone, whereas the lamination zone being defined between the décor embossing roll and a lamination roll, and the distance between the décor embossing roll and the lamination roll in the lamination zone is controlled to keep an overall spacing in a range of between 10 μm and 80 μm, preferably between 20 μm and 50 μm, more preferred between 20 μm and 35 μm.

The overall spacing is understood to mean the shortest distance between the two rolls in the laminating zone. In particular, the spacing is the distance between the radial-most tips of the protrusions of the respective rolls in a plane that extends through the rotation axes of both rolls.

This alternative method has the same advantages as outlined above with respect to the method of manufacturing. In particular, the specific spacing in a range of between 10 μm and 80 μm, preferably between 20 μm and 50 μm, more preferred between 20 μm and 35 μm assures that the finished hygiene product shows a reduced two-sidedness and the optical and haptic appearance of the hygiene product, in particular of the lower side of the hygiene product, is improved.

This is, inter alia, due to the line pressure that is exerted on the webs as they pass through the lamination zone. As the operator is aware of the thickness of the combined set of webs, this enables the operator to choose either a lamination pressure in the lamination zone that enables bonding by an adhesive, or a lamination pressure that enables pressure bonding of the webs. However, in each mode the operator has the freedom to choose a spacing that reduces the two-sidedness of the finished hygiene product.

In particular, to choose the spacing reliably, several methods can be applied. One possible solution includes the step of providing a Schmitz ring on the décor embossing roll and on the lamination roll and controlling the pressure exerted onto the webs such that the Schmitz rings generally remain in contact with one another. By choosing the dimensions of the Schmitz ring and keeping the rings of the two rolls in contact with one another, the operator can choose the spacing reliably and, thus, the line pressure exerted onto the webs.

In a preferred alternative the method comprises the step of pre-treating the first web and/or the second web by embossing at least a first microstructure pattern and/or a first macrostructure pattern therein before the respective webs enter the first décor embossing zone and/or the laminating zone. By embossing at least one of the webs with a microstructure pattern and/or a macrostructure pattern, the hygiene product can be formed to have a specific haptic appearance and characteristics by providing additional smoothness (microstructure pattern) and additional bulk (macrostructure pattern). In addition to that, the embossing of the web or webs also serves as a material reservoir for the treatment in the décor embossing step, since the tissue material is already embossed and therefore has an elongation capacity caused by an increased tensile energy absorption capacity, when it enters the décor embossing zone.

In this connection it is preferred to include the step of controlling the tension and/or the feeding speed of at least one web, in particular of all webs, that are fed through the lamination zone, the décor embossing zone and/or the pre-treating device. This controlling step enables the feeding of the (differently embossed) webs into the lamination zone and/or décor embossing zone without creating any uneven tension within the finished hygiene product. In particular, the different material requirements resulting from the different embossing patterns can be equalized.

In a particularly advantageous embodiment the first web and/or the second web include at least one tissue paper ply. In a further embodiment, the first web and/or second web is pre-treated by laminating together at least two plies of tissue paper in a pre-lamination zone. It is especially preferred to pre-treat the first web and the second web to include two plies of tissue paper each. The aforementioned embodiments lead to a situation in which at least three tissue paper plies are combined in the lamination zone to manufacture a multi-ply tissue paper hygiene product, in particular a three-ply, a four-ply or a five-ply tissue paper hygiene product. Such a multi-ply tissue paper hygiene product could be, for example, a high quality toilet paper or a high quality kitchen towel.

It is also preferred to include the step of pre-treating the first ply and/or the second ply by applying at least an additive, skincare agent and/or a lotion thereon before the respective plies enter the first décor embossing zone and/or the laminating zone. The application of a lotion or an additive enables the manufacture of a lotioned high-quality hygiene product.

The pre-treating step preferably also includes laminating together at least two plies of ply material in a pre-lamination zone to form the first and/or second web. In a preferred step, in order to provide a multi-ply tissue paper hygiene product, in particular a toilet paper hygiene product or a kitchen tissue hygiene product, the first web and/or the second web include at least a tissue paper ply each. To manufacture a high-quality, 4-ply tissue paper hygiene product, the first web and the second web comprise two plies of tissue paper material each. These steps are preferably carried out before a lotion, a skincare agent and/or an additive is applied to the webs in order to generate a reliable lamination of the webs.

Feeding a web comprising more than one ply through the pre-treating zone results in a high quality finished hygiene product with multiple plies, in particular three or four plies. Any suitable higher number of plies is also contemplated, in particular five plies for highest quality toilet paper products.

Furthermore, the pre-treating step may comprise calendering the first web and/or the second web. This kind of pre-treatment can further enhance the haptic appearance of the finished hygiene product.

These advantages can be furthered by providing the décor embossing roll and the laminating roll with steel embossing surfaces, respectively. By this specific arrangement, the surface hardness of the two surfaces is generally equal which enables a lamination of the webs in the lamination zone that significantly reduces any two-sidedness of the finished hygiene product and consequently improves the optical and haptic appearance significantly.

It is to note that the décor embossing roll and the laminating roll in this particular embodiment need to be situated spaced apart from one another in order to prevent the webs and the rolls from being destroyed. The present inventors have found that the values given above, namely a specific spacing in a range of between 10 μm and 80 μm, preferably between 20 μm and 50 μm, more preferred between 20 μm and 35 μm, assures that the finished hygiene product shows a reduced two-sidedness and the optical and haptic appearance of the hygiene product, in particular of the lower side of the hygiene product, is improved. It is to be understood, however, that the rotation of the two rolls needs to be controlled precisely with regard to their angular orientation relative to one another and in a pattern repeat manner. In other words, the décor embossing roll and the laminating roll are driven by separate driving means and need to be controlled precisely. However, the increased complexity of the system compared to the conventional goffra incolla system has the advantages stated above, in particular significantly reduced through-embossing.

In a preferred embodiment, the laminating roll carries an embossing pattern that is mirror-inverted to that of the décor embossing roll whereas the décor embossing roll and the laminating roll are arranged to form the lamination zone in a tip-to-tip arrangement and the rotation of the rolls is controlled to keep this arrangement. This particular embodiment ensures that the pressure exerted on the webs to be bonded in the lamination zone is only exerted in the area of the surfaces of the décor protrusions of the décor embossing roll and the laminating roll. No other areas of the webs receive any pressure that would lead to a through-embossing or a two-sidedness of the finished hygiene product. This leads to a structure in that the two sides of the finished hygiene product have an almost identical optical appearance. In other words, the upper side/outer side and the lower side/inner side of the hygiene product are generally identical.

The term “tip-to-tip” arrangement is commonly also referred to as “foot-to-foot” or “point-to-point”. It basically means that the protrusions of the décor embossing roll are arranged in the embossing zone exactly opposite the protrusions of the lamination roll. This results an arrangement in which the main pressure in the lamination zone is exerted between the embossing protrusions.

Furthermore, the pressure is only exerted in the areas where an adhesive will be present which is coated onto the summits of the upper plies that are conveyed by the décor embossing roll, namely in the areas of the summits of the décor protrusions. To achieve this, the lamination roll could also be completely smooth, as long as it comprises the same surface hardness as that of the décor roll. All this leads to an improved manufacturing process which provides a finished product that is relatively free from any effects of through-embossing and does show a significantly reduced two-sidedness. In other words, the actual outcome of the décor embossing patterns on the upper side/outer side and on the lower side/inner side of the finished hygiene product can be reliably controlled by using the described method.

It is to be noted that in a different embodiment, the surface of the lamination roll can also be completely smooth (no protrusions). In this arrangement, the lamination roll does not comprise any protrusions but due to the generally equal surface hardness of the décor embossing roll and the lamination roll, a two-sidedness of the finished hygiene product can also be reduced effectively.

In a further preferred embodiment, a step of embossing the at least one second web with a décor embossing in a décor embossing zone is provided whereas the décor embossing zone is formed by said laminating roll and a second counter roll, the second counter roll having a surface hardness that is less than that of the décor embossing roll. The counter roll preferably has a rubber surface. In this embodiment, it is also possible to provide a décor embossing pattern in the second web by feeding the second web through a décor embossing zone.

In a further preferred embodiment, the pre-treatment of the first web and/or the second web is effected by embossing a microstructure pattern and/or a macrostructure pattern therein in a first embossing zone and/or a second embossing zone prior to feeding the respective webs through the lamination zone. By providing the microstructure pattern and/or the macrostructure pattern in the respective webs in a separate microstructure and/or macrostructure embossing zone, a high flexibility can be achieved since the décor embossing pattern and the microstructure pattern and/or macrostructure pattern can be changed independently of each other. In other words, it is possible to change the décor embossing pattern without changing the microstructure pattern or the macrostructure pattern and vice versa. Any combinations of microstructure pattern rolls, macrostructure pattern rolls and décor embossing rolls is possible and leads to a high flexibility and lower costs compared to an arrangement in which microstructure patterns, macrostructure patterns and décor patterns are combined on the same roll, since in the latter case, for each combination a set of rolls has to be provided.

There is also the possibility of receiving the first and/or second webs in a form readily embossed with the microstructure patterns and/or macrostructure patterns and subsequently feed these webs through the décor embossing zone and the lamination zone, as described above.

In order to increase the volume or bulk of the finished hygiene product even more, webs with at least two first or two second plies are fed through the first embossing zone and/or the second embossing zone and the two plies are then separated and displaced relative to each other. Consequently, the plies are recombined in the lamination zone in a manner displaced relative to each other due to different path lengths of the respective plies. In other words, the protrusions of at least two adjacent plies which have been embossed together in the first embossing zone or the second embossing zone are not in register with each other any more, but are out of phase such that the bulk of the set of plies is increased.

In another embodiment, the two first plies and/or the two second plies of the webs are separated and displaced relative to each other and then recombined before entering a décor embossing zone in a recombined manner, after a relative displacement. In this case, likewise, the first ply and the second ply are not in register any more when they are recombined but are out of phase with each other, which significantly increases the bulk of the resulting hygiene product.

It is preferred that the first microstructure pattern comprises microstructure protrusions of a protrusion density between 25 to 120 dots/cm², in particular of 30 to 80 dots/cm², more particular of 40 to 60 dots/cm². Preferably, the microstructure embossing roll comprises microstructure pattern protrusions that are chosen to be of a height of 0.3 to 1.0 mm, in particular 0.4 to 0.8 mm, more particular 0.5 to 0.6 mm.

In another preferred embodiment, a macrostructure pattern is embossed in an embossing zone comprises macrostructure protrusions that are chosen to exhibit a protrusion density below 25 dots/cm², in particular of 8 to 20 dots/cm², more particular of 14 to 17 dots/cm². Preferably, the macrostructure pattern is embossed in an embossing zone whereas a macrostructure embossing roll comprises macrostructure pattern protrusions that are chosen to be of a height of 0.3 to 5.0 mm, in particular 1.0 to 2.5 mm, more particular 1.0 to 1.8 mm.

In order to bond the webs together, a gluing unit can be used to apply glue or an adhesive to at least one of the webs before it enters the lamination zone. In order to emphasize the décor pattern, coloured glue can be used, which is consequently distributed in the areas where the décor protrusions are present.

In a preferred embodiment, the décor embossing roll comprises a décor pattern having décor pattern protrusions of a height of 0.3 to 5.0 mm, in particular 0.8 to 2.5 mm, more particular 0.8 to 2.0 mm.

It is preferred that the décor embossing roll comprises décor pattern protrusions of at least a first height and microstructure pattern protrusions and/or macrostructure protrusions of at least a second height, the second height being lower than the first height. It is, furthermore, preferred that the lamination roll comprises a décor pattern having décor pattern protrusions of a third height and a microstructure protrusions and/or a macrostructure protrusions of a fourth height, the fourth height being equal to or larger than the third height. These variants of the invention make it possible to vary the embossing patterns while still avoiding a two-sidedness of the finished hygiene product with regard to the décor protrusions since the lamination roll and the décor embossing roll constitute the lamination zone still in such a manner that only the décor embossing protrusions of the décor embossing roll and the lamination roll provide any pressure to the webs in a foot-to-foot manner.

It is contemplated that only one of the décor embossing rolls and the laminating roll carries an additional microstructure pattern and/or macrostructure pattern providing an additional structure to the first or second webs that are fed through the décor embossing zone. The respective other second or first webs are embossed with a microstructure pattern and/or macrostructure pattern before they are fed through the lamination zone or through the respective other décor embossing zone.

In a further preferred embodiment of the invention, additional webs or plies, in particular one or two additional webs, are fed through the lamination zone. It is preferred when at least one of the additional webs is pre-treated, in particular by embossing a microstructure pattern and/or a macrostructure pattern therein. The application of additional webs results in a high quality hygiene product, in particular a hygiene product with three of four plies of material bonded together. Any sensible higher number of plies is also contemplated, in particular five or more plies.

An apparatus for manufacturing a hygiene product comprises a lamination zone that is formed by a décor embossing roll and a lamination roll whereas the décor embossing roll and the lamination roll have a generally equal surface hardness. A first décor embossing zone is provided, the décor embossing zone being located upstream of the lamination zone and being defined between the décor embossing roll and a first counter roll. Furthermore, at least one pre-treating device is located upstream of the lamination zone and of the décor embossing zone, the pre-treating device being arranged to pre-treat at least one web.

The apparatus described above has the same advantages as described with regard to the method for manufacturing a hygiene product.

The pre-treating device preferably comprises an embossing zone for embossing a microstructure pattern and/or a macrostructure pattern into the respective web, wherein the embossing zone is preferably defined between a microstructure embossing roll and/or a macrostructure embossing roll and an elastic roll.

In another preferred embodiment, the pre-treating device comprises an application device for the application of at least a lotion and/or an additive and/or a skin-care agent to the respective web.

The above objects are, furthermore, solved by a hygiene product. Accordingly, the hygiene product comprises at least a first web that is embossed with a microstructure pattern and/or a macrostructure pattern, and a décor embossing pattern comprising décor embossing protrusions, and at least a second web, whereas the first web and the second web being bonded to each other in the areas of the décor embossing protrusions of the first web.

In an advantageous embodiment, the second web extends generally in the plane through the bonding areas of the second web that are bonded to the summits of the décor protrusions of the first web. In other words, the second web is substantially flat, regardless if it is attached to the upper webs or not.

In a preferred embodiment, the hygiene product is arranged such that at least two plies of a web are fed through one microstructure embossing zone and the two plies are then separated and displaced relative to each other such that a structure results where two plies with basically the same microstructure embossing pattern are arranged such that the protrusions of the microstructure pattern are not in register with each other but are out of phase with each other such that the bulk is increased. These two plies with the out-of-phase microstructure patterns are, however, embossed with the décor embossing protrusions which are arranged in the same position for both of the plies. In other words, the décor embossing protrusions are not out of phase but are in register with each other.

In all of the above-mentioned embodiments and methods, at least one of the upper and lower webs carries a microstructure pattern and/or a macrostructure pattern in combination with a décor embossing pattern.

Alternatively, one of the upper and lower webs is structured by a TAD process and thus carries a (TAD specific) microstructure kind of pattern. In other words, all combinations of upper and lower webs which are structured by a TAD process or carry a microstructure pattern resulting from any other production process are within the scope of the invention.

### BRIEF DESCRIPTION OF THE DRAWINGS

In the following, the invention is described, by way of example only, with reference to the accompanying drawings in which:

FIG. 1 is a schematic illustration of the method for manufacturing a hygiene product according to a first embodiment of the invention;

FIG. 2 is a schematic representation of the method for manufacturing a hygiene product in according to a second embodiment;

FIG. 3 is a schematic illustration of the method for manufacturing a hygiene product according to a third embodiment;

FIG. 4 is a schematic representation of the method for manufacturing a hygiene product in a fourth embodiment in which two plies of a web that are fed through one microstructure and/or macrostructure embossing zone, are separated, displaced with respect to each other and then recombined;

FIG. 5 is a schematic representation of the method for manufacturing a hygiene product according to a fifth embodiment in which two plies of a web that are fed through one microstructure and/or macrostructure embossing zone and are separated, displaced with respect to each other and recombined; FIG. 5 also shows pre-treatment of a combination of pre-embossing (e.g. microembossing) and laminating two first plies to a first two-ply laminated web with subsequent application of a lotion, skin-care agent or an additive to said two-ply web, wherein this two-ply laminated web will be conveyed to a first embossing zone upstream the lamination zone;

FIG. 6 is a schematic illustration of the method for manufacturing a hygiene product in which at least two upper and two lower plies of the webs are fed through each of the microstructure and/or macrostructure embossing zones and both plies are separated, displaced and recombined before entering the respective décor embossing zones;

FIG. 7 is a schematic cross-section of the lamination nip with Schmitz rings, seen in the machine direction;

FIG. 8 is a schematic cross-section through a sheet of a hygiene product according to a first embodiment;

FIG. 9 is a schematic cross-section through a sheet of a hygiene product according to a second embodiment;

FIG. 10 is a schematic cross-section through a sheet of a hygiene product according to a third embodiment;

FIG. 11 is a schematic cross-section through a sheet of a hygiene product according to a fourth embodiment;

FIG. 12 is a schematic cross-section through a sheet of a hygiene product according to a fifth embodiment;

FIG. 13 is a schematic cross-section through a sheet of a hygiene product according to a sixth embodiment; and

FIG. 14 is a schematic cross-section through a sheet of a hygiene product according to a seventh embodiment.

### DETAILED DESCRIPTION OF PREFERRED EMBODIMENTS

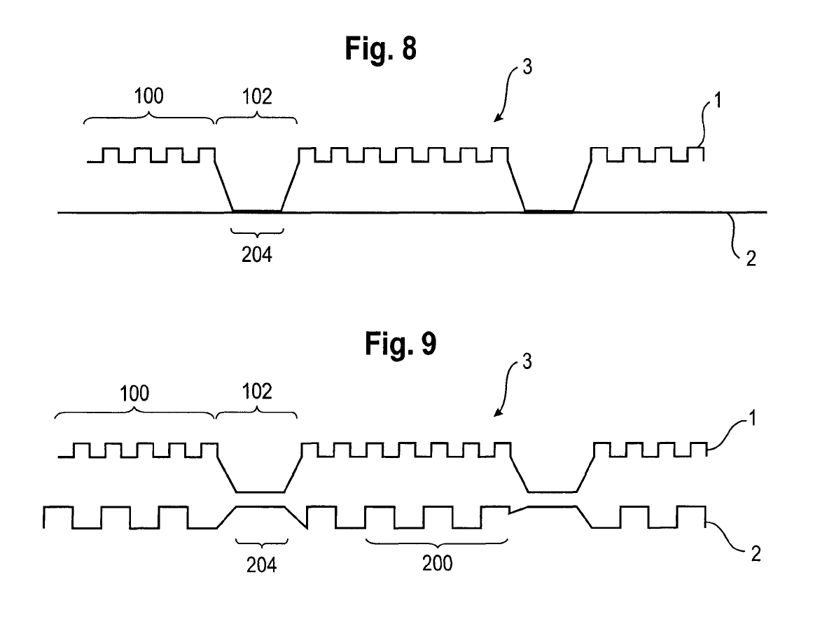

In the following description of preferred embodiments of the invention, corresponding parts or elements in the different drawings will be denoted by the same reference numerals and repeated description thereof will be omitted. In the schematic cross-sections through sheets of hygiene products in FIGS. 8 to 14, the heights of the protuberances of the microstructure patterns, the macrostructure patterns and the heights of the décor protuberances of the décor embossings were selected to clarify the invention and are not drawn to scale.

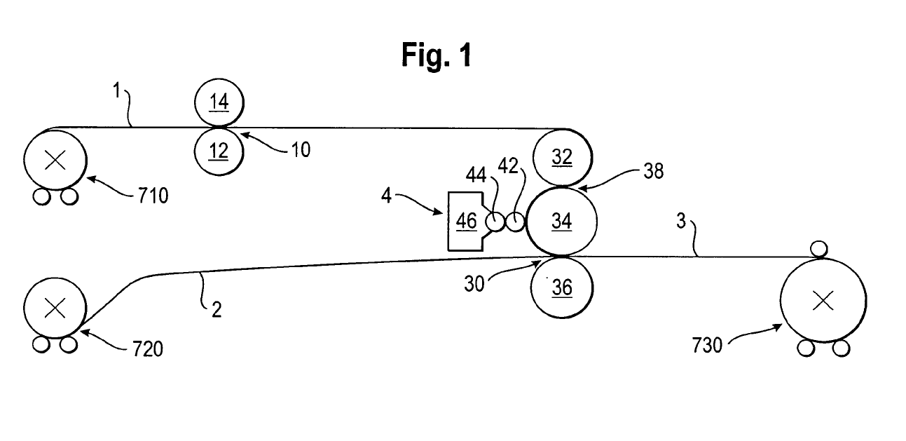

FIG. 1 shows a first embodiment of the method for manufacturing a hygiene product, in particular a multi-ply tissue paper hygiene product, as well as an arrangement for carrying out the method. A first web 1 and a second web 2 are provided separately. Typically, the first web 1 and the second web 2 are constituted by a first ply 1 of tissue paper and a second ply 2 of tissue paper. The first ply 1 is provided in the form of a roll (so-called mother roll) that is situated rotatably in an unwinding unit 710. Likewise, the second ply 2 is provided in the form of rolled material (so-called mother roll) and is situated rotatably in an unwinding unit 720.

In order to achieve a maximum softness of the final product, it is necessary that the unwinding direction will be formed in such a way that the soft side (Yankee cylinder side) of the outer ply of a multi-ply tissue web forms the outer side of the outer ply of the finished tissue product 710, 720. This basic principle should be applied for all embodiments shown in FIGS. 1 to 6.

The first web 1 is fed through a pre-treatment device in the form of a first pre-embossing zone 10 that is a microstructure embossing zone which comprises a steel roll 14 carrying microstructure embossing protrusions in an arrangement that corresponds to the desired microstructure embossing pattern, and a counter roll 12 that has an elastic surface. The surface of the counter roll 12 is typically made from a rubber material that has a hardness between 30 to 80 Shore A, in particular between 40 and 60 Shore A. In the first microstructure embossing zone 10, the first web 1 receives a microstructure embossing pattern corresponding to the microstructure embossing protrusions on the steel roll 14. The microstructure embossing protrusions on the surface of the steel roll 14 preferably have a protrusion density between 25 to 120 dots/cm², in particular of 30 to 80 dots/cm², more particular of 40 to 60 dots/cm². The web 1 that is fed through the microstructure pre-embossing zone 10 is, consequently, embossed with this microstructure pattern.

In the embodiment shown in FIG. 1, the second web 2 is not embossed with a microstructure pattern but remains flat and unembossed before it enters the lamination zone 30 described below.

Preferably, the feeding speeds of the first web 1 and the second web 2 in the lamination zone are identical in order to minimise any warping of the finished hygiene product. Accordingly, feeding speed of the first web 1 before it enters the microstructure pre-embossing zone 10 needs to be higher than the feeding speed of the flat second web 2 since in the pre-embossing zone 10 a portion of the web material is bend out of the plane of the web 1 and is converted to the microstructure pattern. Thus, material length is “used up” in the pre-embossing zone 10. In the embodiment shown, the speed and the web tension of each web has to be controlled accordingly.

The first web 1 is conveyed, after passing through the microstructure pre-embossing zone 10, towards a first décor embossing zone 38. The décor embossing zone 38 is defined between a décor embossing roll 34 and a counter roll 32. The décor embossing roll 34 carries décor protrusions on its surface that correspond to the décor embossing pattern that is intended to be embossed into the first web 1. The décor embossing roll preferably has a surface made of steel. The counter roll 32 comprises an elastic surface and is preferably made of a rubber material with a surface hardness between 30 to 80 Shore A, preferably between 40 and 60 Shore A. In the first décor embossing zone 38, the microstructure embossed web 1 receives a décor embossing corresponding to the décor protrusions on the surface of the décor embossing roll 34.

Subsequent to passing through the first décor embossing zone 38, the first web 1, now carrying the décor embossing protrusions and generally sticking to the décor embossing roll 34, passes a glue application unit 4 which applies glue or an adhesive to the summit portions of the décor protrusions of the web 1.

The glue application unit 4 comprises a glue application roll 42 which is in direct contact with the summits of the décor protrusions, an Anilox roll 44 that is in contact with the glue application roll 42, and an adhesive chamber 46 that enables a blade controlled application of glue to the Anilox roll 44. In the case that a special accentuation of the décor embossings is desired, coloured glue can be used to emphasize the décor embossing.

Subsequent to the application of the glue, web 1, now carrying glue on the summit portions of the décor protrusions, passes through the lamination zone 30 together with the completely flat and unembossed second web 2.

The lamination zone 30 is formed by the décor embossing roll 34 and a lamination roll 36. The décor embossing roll 34 and the lamination roll 36 have the same surface hardness and are in particular steel rolls. The lamination roll 36 carries a décor embossing pattern constituted of décor embossing protrusions that are mirror-inverted with regard to the décor embossing protrusions of the décor embossing roll 34. The décor embossing protrusions of the décor embossing roll 34 and the décor embossing protrusions of the lamination roll 36 are arranged and synchronized such that they are arranged in a tip-to-tip manner. In other words, the pressure in the lamination zone 30 is applied to the first web 1 and second web 2 mainly in the area of the décor protrusions of the décor embossing roll 34 and the lamination roll 36. The lamination roll 36, however, could also be completely smooth (without any protuberances) in order to achieve the desired results. After passing through the lamination zone 30, the two webs 1 and 2 are bonded together at the summit portions of the décor protrusions and form a laminated intermediate hygiene product 3, which is then taken up on a re-winding unit 730.

It is to be noted that the distance between the décor embossing roll 34 and the lamination roll 36 in the lamination zone 30 is controlled to keep an overall spacing in a range of between 10 μm and 80 μm, preferably between 20 μm and 50 μm, more preferred between 20 μm and 35 μm.

The spacing is understood to mean the shortest distance between the two rolls 34, 36 in the lamination zone 30. In particular, the spacing is the distance between the radial-most tips of the protrusions of the respective rolls 34, 36 in a plane that extends through the rotation axes of both rolls. As the thickness of the webs 1, 2 is known, the line pressure exerted on the webs 1, 2 in the lamination zone 30 can be adjusted by adjusting the spacing of the lamination zone 30.

It will be appreciated that the décor embossing roll 34 and the lamination roll 36 both need to be driven in order to achieve and keep the tip-to-tip arrangement of the protrusions of the respective rolls. In particular, the rotation of the rolls has to be controlled precisely in a pattern matching manner.

In the method and embodiment described with respect to FIG. 1 and in the methods and embodiments described in the following, it is frequently mentioned that a first web and a second web are used. It will be appreciated, however, that the first web 1 and the second web 2 can be comprised of several plies of material, in particular two plies, each. This would, consequently, result in a final multi-ply hygiene product with three, four, five or more plies.

Additionally, it is envisioned that webs of multiple plies are fed through the lamination zone such each of the plies or sets of plies are fed through separate pre-treatment devices, in particular microstructure embossing zones and/or macrostructure embossing zones.

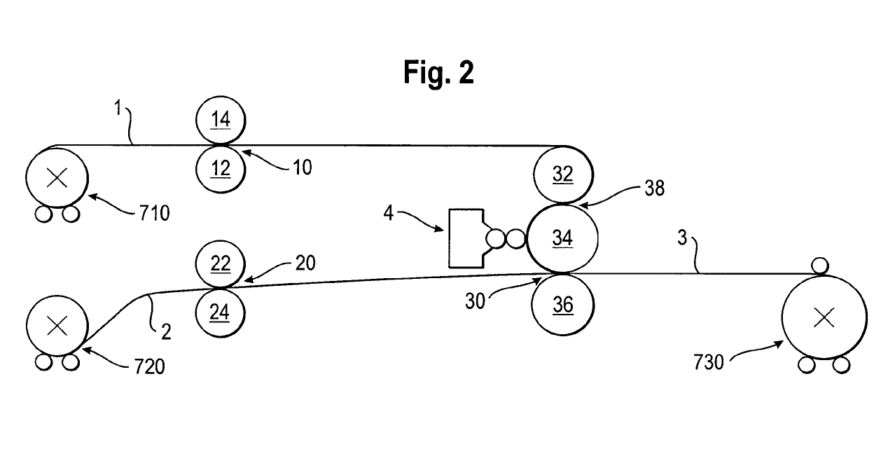

In the method and arrangement shown in FIG. 2, the method basically corresponds to that of FIG. 1. There is, however, made provision that the second web 2 is as well pre-treated, here by feeding it through a second embossing zone that is a macrostructure pre-embossing zone 20, before it enters the lamination zone 30. The macrostructure embossing zone 20 is formed by a steel roll 24 and a counter roll 22. The steel roll 24 carries on its surface macrostructure protrusions that correspond to the macrostructure pattern that is desired to be embossed in the second web 2. The macrostructure protrusions carried on the steel roll 24 are chosen to exhibit a protrusion density below 25 dots/cm², in particular of 8 to 20 dots/cm², more particular of 14 to 17 dots/cm².

The remaining method and arrangement corresponds to that described with respect to FIG. 1. The resulting hygiene product 3 has, however, a structure that includes microstructure embossings in the first web 1 as well as macrostructure embossings in the second web 2 additionally to the décor embossing protrusions in the first web.

Due to the tip-to-tip arrangement of the décor protrusions of the décor embossing roll 34 and the décor protrusions of the lamination roll 36, it is ensured that a through-embossing of the second web 2 is significantly reduced. Since in the lamination zone a pressure on the webs 1, 2 to be laminated together is only exhibited in like areas, namely in the areas of the décor protrusions, the forces exerted on the web are carried by the respective other décor protrusion. Consequently, a through-embossing or a two-sidedness of the resulting hygiene product is reduced or even avoided and the décor embossings are not carried through to the respective other side. An embossing with the décor embossings takes only place in the décor embossing zone, where an interaction between the décor embossing roll 34 and a counter roll 32 of a lesser surface hardness permits such embossing.

However, it will be appreciated that in the area of the décor embossing pattern any microstructure embossing and/or macrostructure embossing that is present in the respective webs will be destroyed in the décor embossing zone and/or in the lamination zone. This is due to the fact that the lamination zone is situated downstream to the pre-treatment devices and zones.

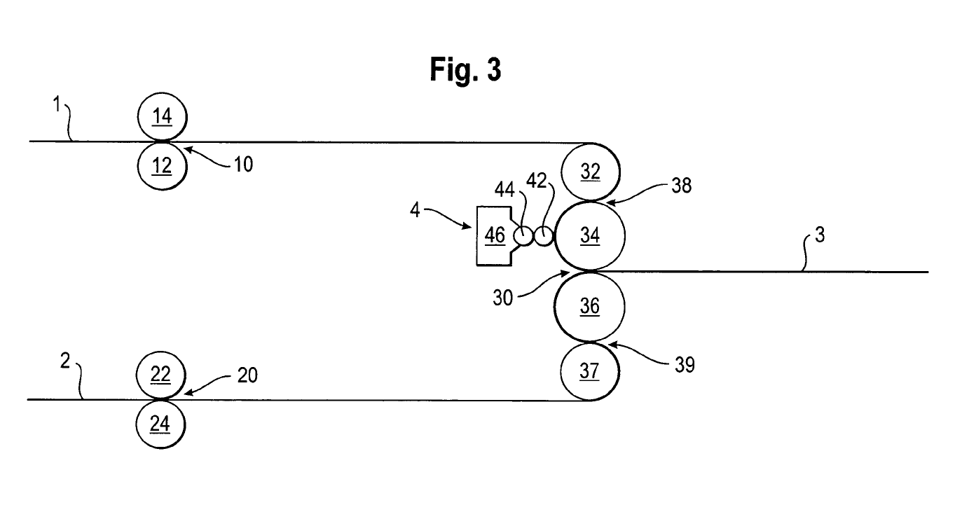

FIG. 3 shows a variant of FIG. 2. In this embodiment, an additional décor embossing zone 39 is provided between the lamination roll 36 and a corresponding counter roll 37. Here again, the counter roll 37 exhibits an elastic surface and is preferably made from a rubber material.

The embodiment and method shown in FIG. 3 ensures that the second web 2 as well receives a décor embossing in the second décor embossing zone 39. The second web that is by then décor embossed is combined with the décor embossed first web at their respective décor protrusions. This leads to a hygiene product that is décor embossed on the upper side of the finished hygiene product 3 as well as on its lower side.

In the case that the décor embossing protrusions of the décor embossing roll 34 have the same dimensions, in particular the same height, as that of the laminating roll 36, the method and arrangement of FIG. 3 results in a laminated hygiene product 3 which has a generally symmetrical appearance of the décor embossing on the upper/outer and the lower/inner side of the finished hygiene product. In other words, the upper side and the lower side of the finished hygiene product 3 are generally identical, at least with regard to the décor protrusions.

In this variant, it is also contemplated to feed a first web 1 with at least two first plies and a second web 2 with at least two second plies to the lamination zone in order to manufacture a 3-ply or 4-ply hygiene product.

In a variant not shown, the laminating roll 36 could carry not only the décor protrusions but also a microstructure/macrostructure pattern, whereas the décor protrusions exhibit a height that is higher than that of the microstructure/macrostructure protrusions. In this case, the second macrostructure pre-embossing zone 20 could be omitted since the second web 2 would be décor embossed as well as microstructure/macrostructure embossed in the second décor embossing zone 39 between the lamination roll 36 and the second counter roll 37. In this variant, the second counter roll 37 preferably would show a surface hardness of 50 to 55 Shore A in order provide an embossing zone that enables embossing of both patterns into the web.

It is, furthermore, contemplated to provide the microstructure embossings and/or the macrostructure embossings in the first web 1 and/or the second web 2 externally such that the first pre-embossing zone 10 and the second pre-embossing zone 20 could be omitted. Accordingly, the first web and/or the second web could be pre-treated in a separate unit and then provided to the present method as a precursor. In other words, webs 1, 2 that are microstructure/macrostructure embossed could be fed into the first décor embossing zone 38 and the lamination zone 30 or the second décor embossing zone 39. Such a pre-treated web could be delivered in the form of a semi-finished material roll (precursor roll).

The arrangement shown in the above Figures exhibits a high versatility since the microstructure embossing steel roll 14, the macrostructure embossing steel roll 24, as well as the décor embossing roll 34 and lamination roll 36 can be exchanged separately and independently of each other. In other words, a change of the microstructure embossing pattern and/or the macrostructure embossing pattern is easily possible by exchanging the steel rolls 14, 24 carrying the respective embossing patterns. Likewise, the décor embossing pattern can easily be changed by exchanging the décor embossing roll 34 as well as the lamination roll 36. A roll that combines décor embossings and microstructure/macrostructure embossings is, thus, not necessary. This is in particular advantageous since these rolls comprising different heights are expensive to manufacture as well as the dimensional accuracy of the protrusions of lower height is not easy to ensure.

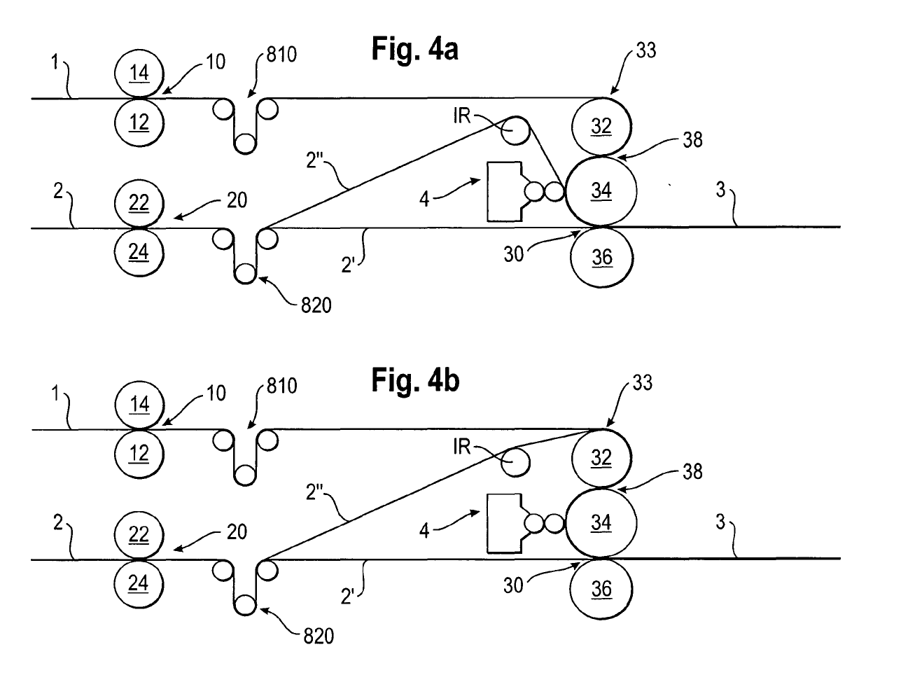

FIG. 4a shows a different embodiment of the present invention in which at least the second web 2 comprises two plies 2′, 2″ (two separate second plies) , which are fed together through the microstructure and/or macrostructure pre-embossing zone 20. Consequently, both plies 2′, 2″ receive an identical, or almost identical, embossing pattern in the second macrostructure pre-embossing zone 20. After passing through the second macrostructure pre-embossing zone 20, the second plies 2′, 2″ are separated and displaced with respect to each other.

In the embodiment shown in FIG. 4a, this displacement between the plies 2′, 2″ is carried out by the provision of different path lengths of the second plies 2′, 2″ before they are recombined in the lamination zone 30. Ply 2′ is fed directly into the lamination zone 30, ply″ is fed to the lamination zone 30.

The other ply 1 is fed via a first pre-embossing zone 10 and through a separate embossing zone 33 that is provided between the counter roll 32 and an embossing roll 31 that can carry microstructure protrusions, macrostructure protrusions or both. Ply 1 is then feed through the lamination zone 30.

Consequently, the resulting hygiene product 3 comprises a structure in which the macrostructure pattern that was embossed in the second macrostructure embossing zone 20 is carried through by the plies of the second web 2. The two second plies 2′, 2″ are, however, shifted with regard to each other when recombined in the lamination zone 30, such that the macrostructure embossing protrusions are out of phase.

In other words, the macrostructure protrusions of the second plies 2′, 2″ are not in register with each other any more. This increases the bulk of the resulting hygiene product 3.

The resulting hygiene product is a three-ply hygiene product if the first web 1 comprises only one ply of material. It is also contemplated to manufacture a four-ply hygiene product or a five-ply hygiene product by feeding, e.g., as the first web 1 two plies through the first embossing zone 10 and as the second web 2 two or three plies through the second embossing zone 20.

It is also contemplated to feed each of the plies of the respective webs through separate pre-treating zones in order to apply individual pre-treatments to the webs and/or the plies before they enter the lamination zone.

In the embodiment shown in FIG. 4a, no unwinding units or rewinding units are shown. Accordingly, this embodiment is intended to show an in-line processing step that is in line with a paper converting step upstream of the apparatus shown in FIG. 4a and further steps, such as cutting, rolling, perforating, folding, printing, confectioning and packaging, downstream the apparatus. However, it could also be an off-line section and be provided with unwinding units and a rewinding unit.

Furthermore, in the embodiment shown tension control units 810 and 820 are provided that enable controlling the tension of the first web 1 and the second web 2 after they have passed through the first pre-embossing zone 10 and the second pre-embossing zone 20.

FIG. 4b relates to an apparatus identical to that shown in FIG. 4a with the exception that the second ply 2″ is conveyed via an idler roll to the first décor embossing zone 38 first, and then to the lamination zone 30.

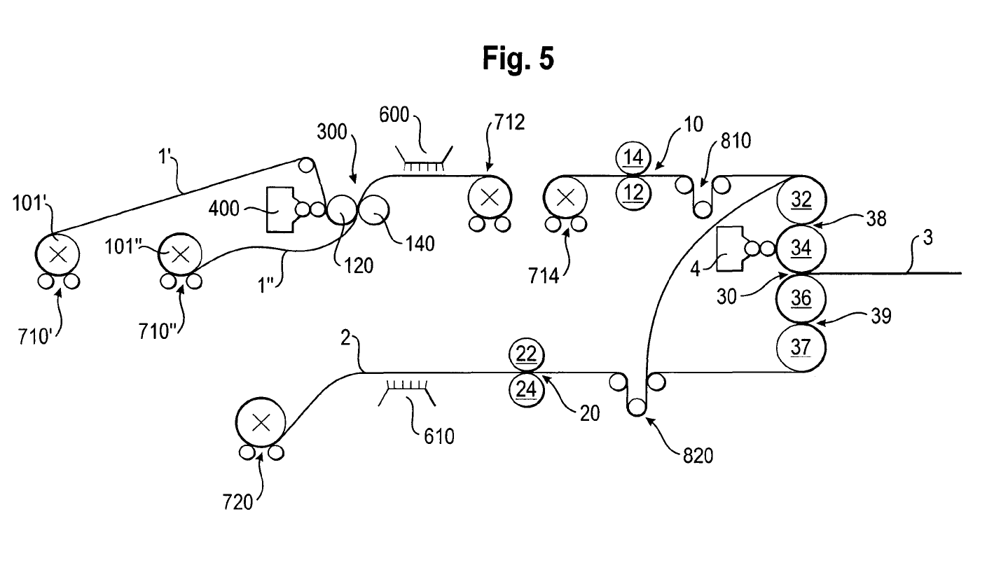

FIG. 5 shows an alternative of FIG. 4, in which one second ply 2′ is fed through the second décor embossing zone 39 and another second ply 2″ is fed through the first décor embossing zone 38. The resulting hygiene product 3 shows, again, more bulk as the macrostructure protrusions of the two second plies 2′, 2″ are not in register with each other but rather out of phase when being recombined.

In the embodiment shown in FIG. 5, the first plies 1′, 1″ are pre-treated by laminating them together in a pre-lamination zone 300 that is defined between a first pre-embossing roll 120 and a counter roll 140. The plies 1′, 1″ are provided from material rolls 101′, 101″ that are located in unwinding units 710′, 710″. Glue is applied in a glue application unit 400 to the inner surface of one ply 1′ and the plies 1′, 1″ are then bonded together in the pre-lamination zone 300 and wound up into a material roll in a rewinding unit 712.

In the embodiment shown, the web 1 manufactured in such a manner is used as a semi-finished product/web for the manufacturing method shown downstream of the rewinding unit 712. It will be appreciated that the same method of pre-treating can be applied to the second web 2.

To use the pre-treated web 1 in the embossing steps, the material roll of the web 1 is placed on a unwinding unit 714 and the web material is fed through the first embossing zone 10, as has been explained above.

Web 1 can be pre-treated using by the application of an additive, skincare agent and/or lotion using a respective applicator 600 that applies the respective treatment onto the outside of the web 1. The second web 2 can also be pre-treated by application an additive, skincare agent and/or lotion using a respective applicator 610 that applies the respective treatment onto the outside of the web 2.

Although for simplicity reasons a spraying applicator 600, 610 is mentioned, other application devices such as a coating apparatus, rotogravure printing or flexographic printing or a rolling apparatus can also be used.

Turning now to the different types of additives, skincare agents and/or lotions that can be used in hygiene products, it will be appreciated that for the purpose of pre-treating the web, the web is frequently provided with substances, additives, auxiliary substances and other treatment chemicals.

In accordance with the invention, this term will also cover any substance or blends of substances generally referred to as treatment chemicals and normally applied to the tissue after the drying and creping step on the Yankee cylinder.

Treatment chemicals may have an influence on physical properties, e.g. softness, particularly bulk softness, strength in the dry and wet states, rate of absorption of liquids, particularly that of water or oil, or the structural strength of the tissue/tissue product itself, and/or they may contribute to their varying use, e.g. in the field of skincare and protection, healthcare, etc. “Lotions” are also particularly referred to in the latter case.

Household towels for example, particularly kitchen towels and to an even greater extent paper towels, require strength, especially in the wet state, and high suction capacity so as to satisfy consumer demands. In the case of toilet paper, a combination of dry strength plus good softness is more likely to determine suitability in practice and acceptance among consumers. In the case of other tissue products such as handkerchiefs or facial wipes, surface softness and bulk softness are predominant properties which, in addition to strength, define the serviceability of these products.

Cosmetic components contained in the product, though particularly present on its outer surfaces also play an important part in the latter tissue products. Such cosmetic components include, inter alia, perfumes, moisturizers, skin care agents, healthcare substances such as panthenol or the active camomile ingredient bisabolol.

It is important in the case of cosmetic components to achieve an optimum transfer of the components such as care agents or moisturizers from the tissue product to the skin—optimum in the sense of an adequate quantity of such components—so as to promote the desired effect. High amounts of the cosmetic substances to be applied to the tissue are necessary for this purpose. On the other hand, the tissue itself must not feel unpleasant or e.g. leave behind a wet feeling on the skin.

Manufacturers of tissue products are therefore especially faced with the challenge of achieving a particular balance between the various, frequently contradictory parameters in order to use this balance to obtain the optimum combinations of features required by consumers for the desired final products. The article entitled “Weichheit und Weichmachung von Hygiene-Tissue” in the Wochenblatt für Papierfabrikation, No. 11/12, 1988, pages 435 et seq., describes in detail the properties of hygiene tissue and discusses their importance to tissue products in different applications.

Thus, one of the principal market demands to be met by manufacturers is a general improvement in softness in all areas of tissue products. Properties such as the softness of a tissue product are defined in terms of their basic design by the production process, particularly by preliminary TAD and the choice of raw and auxiliary materials.

Softness is an important property of tissue products such as handkerchiefs, cosmetic wipes, toilet paper, serviettes/napkins, not to mention hand or kitchen towels, and it describes a characteristic tactile sensation caused by the tissue product upon contact with the skin.

Although the term “softness” is generally comprehensible, it is extremely difficult to define because there is no physical method of determination and consequently no recognized industrial standard for the classification of different degrees of softness.

To be able to detect softness at least semi-quantitatively, softness is determined in practice by means of a subjective method. To do so, use is made of a “panel test” in which several trained test persons give a comparative opinion.

In simplified terms, softness can be subdivided into its main characteristics, surface softness and bulk softness.

Surface softness describes the feeling perceived when e.g. one's fingertips move lightly over the surface of the sheet of tissue. Bulk softness is defined as the sensory impression that is produced by a tissue manually compressed during the process of compression.

Skincare agents can be used to prevent, alleviate or heal dermatitis.

A skincare agent can consist, in its physical form, of a solution, suspension, cream, lotion, ointment, paste, gel, foam, aerosol or capsule, or it can be present in solid phase as particles, flakes, fibres, films, foams, waddings, sticks, etc. In the following description, a cream, lotion or ointment is preferably used, but others of the above-described forms are of course also conceivable.

Skincare agents can include lipids (fats, oils, waxes), solvents (including water), water-soluble substances, surface-active agents (emulsifiers, surfactants), viscosity-regulating substances, pH-regulating substances, preserving agents, complexing agents (e.g. chelates), delivery systems (e.g. liposomes, microcapsules, etc), pigments, perfumes, and active substances (also pharmaceutical agents). The lipids are usually emulsified in water, known as o/w emulsion, or water is emulsified in the lipid phase, known as w/o emulsion.

Skincare agents can include lipids such as:

paraffins (alkanes) with 12-35 carbon, for example paraffin oil (mineral oil) or petrolatum (vaseline).

Triglycerides, refined and/or hydrogenated, animal or vegetable with preferably carbon chain lengths of under C-18 (e.g. milk fat, coconut oil Cocous nocifera, palm-kernel oil Elaeis guineeis), animal or vegetable with unsaturated C-18 fatty acids (e.g. Japan wax Rhus succesdanes, tallow fat, soybean oil Glycerin soya, peanut oil Arachais hypogaea, maize oil Zea mays, sunflower oil Helanthus annus, grapeseed oil Vitis vinifera, safflower oil Carthamus tinctorius, sweet almond oil Prunnus amygdalus dulcis, hazelnut oil Corylus americana, walnut oil Juglans regia, olive oil Olea europasa, avocado oil Persea gratissima, sesame oil Sesamum indicum, tall oil, Tallol, cottonseed oil Gopssypium, palm oil Elaesis guineensis, rice oil Oryza sativa, rape oil Canola, apricot-kernel oil Prunus armeniaca, cocoa butter Theobroma cao, shea butter Butyrospermum parkii, wheatseed oil Triticum vulgare, Bassia latifola, animal or vegetable with carbon chains over C-18 (e.g. beeswax Cera alba, shellac wax Shellac cera, meadowfoam seed oil Limnanthes alba, rapeseed oil Brassica capmestris, cucumberseed oil Borago officinalis, linseed oil Linum usitatissimum, ricin oil Ricinus communis, veronia oil

Veronia galamensis, jojoba oil Buxus chinensis, candlewax Euphorbia cera, ongokea oil Ongokea gore).

Fatty alcohols with straight or branched carbon chain lengths of 12-32 carbons. For example, cetyl alcohol or stearyl alcohol.

Fatty acid esters with 12-32 carbons. For example, methyl palmitate, methyl stearate, isopropyl myristate, isopropyl laurate, isopropyl palmitate, isopropyl stearate, octyl palmitate, octyl stearate or octyl laurate.

Polyalcohols: For example, sugar alcohols or polyglycerols. Complex lipids: For example, phospholipids or sphingolipids (ceramides).

Waxes: Of animal origin, for example beeswax or lanolin. Of vegetable origin, for example carnauba or candelilla. Of mineral origin, for example ozocerite or ceresin.

Polysiloxanes: Straight, branched or cyclic. For example, polydimethyl-siloxane (dimethicone) or polydiethylsiloxane.

Skincare agents can include emulsions such as: Emulsions of one or more fats with hydrophilic substances such as water, glycerol, polyethylene glycol (PEG), propylene glycol, butylene glycol, sorbitol, silicone glycols or the like or mixtures thereof.

Skincare agents can include substances which adsorb irritating components in urine or excrement. For example, clay mineral (bentonite, kaolin, montmorillonite, etc), silicon oxide compounds (quartz, zeolites, water glass, etc) or activated charcoal. The substances can advantageously have been activated to be more adsorbent by means of various treatments, for example with quaternary ammonium compounds.

Skincare agents can include enzyme inhibitors. For example, metal salts of iron or zinc, trace amounts of heavy metal ions such as copper or silver, ethylene diamine tetraacetic acid (EDTA), soybean trypsin inhibitor, lima bean protease inhibitor, maize protease inhibitor, stearylglycyrrhetinate, glycerol triacetate, betaine compounds, sulphobetaine compounds, cholestyramine, p-guanidinobenzoates.

Skincare agents can include pH-regulating additives. For example, organic or inorganic acids such as adipic acid, ascorbic acid, benzoic acid, citric acid, malic acid, tartaric acid, lactic acid, phosphoric acid or hydrochloric acid. Or buffers made for example from said acids with corresponding salts. Can also include polymeric acids, for example polyphosphoric acid or polyacrylic acid.

Skincare agents can also include additions of probiotic microorganisms, characterized by being antagonistic towards undesired microorganisms, e.g. urinary tract pathogens or skin infection pathogens. Examples of probiotic microorganisms which can be used are individual strains or mixtures of several strains of lactic acid bacteria taken from the species Lactobacillus acidophilus, Lactobacillus curvatus, Lactobacillus plantarum or Lactococis lactis.

Skincare agents can also include more or less active substances such as:

Anti-inflammatory agents, e.g. acetylsalicylic acid, allantoin, azulen, alpha-bisabolol, flavonoids, glycyrrhizinic acid, ichthammol (Inotyol®), tannins. astringents (vasoconstrictors), for example TiO, ZnO (and other Zn compounds), aluminium acetate solution, aluminium tartrate solution (and other Al compounds), ethanol or ethanol-based solutions.

Aloe vera (Aloe barbadensis), alpha-hydroxy acids (citric acid, tartaric acid, lactic acid, malic acid, etc.), algae extract, ascorbic acid (vitamin C), vitamin A compounds (retinol, retinal, tretinoin and isotretinoin), avocado sterols, betaine (trimethylglycine), ceramides, grapeseed extract, avena sativa (oat), calendula, chamomile, farnesol, hamamelis (witch hazel), salvia officinalis.(sage), essential fatty acids, flavonoids, phytosphingosine, phytosterols, hyaluronic acid, yeast extract, chitosan, milk protein (Lactis proteinum), pantenol (provitamin B5), polysaccharides, rosemary extract, tocopherol (vitamin E), ubiquinone (coenzyme Q10), urea.

Antimicrobial agents, for example amorolfin, antibiotics, bacitracin, benzalkonium chloride, benzetonium chloride, cetrimide, fusidic acid, gentian violet (methylrosaniline chloride), hexachlorophene, hexylresorcinol, imidazole derivatatives (for example biphonazole, econazole, ketoconazole, chlotrimazole, miconazole), chlorhexidine, nystatin, povidone-iodine, terbinafin, triclosan, hydrogen peroxide.

Antiviral agents, for example acyclovir, imiquimod, podophyllotoxin, podophilox, cidofovir, penciclovir, vidarabin, idoxuridine, trifluridine, tromantadine, lamivudine.

Skincare agents can also include glucocorticoids, preferably of low potency, for example hydrocortisone, or antipruritic, for example antihistamines or local anaesthetics (e.g. lidocaine).

Skincare agents can also consist of ready-made mixtures of skin ointments, creams and lotions. For example, Necesse® Lotion (ingredients: aqua, propylene glycol, liquid paraffin, octyl octanoate, urea, PEG-8 distearate, steareth-2, steareth-21, betaine, lactic acid, tocopheryl acetate, dimethicone, tromethamine, methylparaben, propylparaben, perfume), Necesse® Skin Cream (ingredients: aqua, liquid paraffin, octyl stearate, sodium chloride, urea, glyceryl stearate, stearic acid, cetearyl alcohol, PEG-30 stearate, tocopheryl acetate, tromethamine, dimethicone, methylparaben, sorbic acid, propylparaben, perfume), Necesse® Barrier Cream (ingredients: petrolatum, glycerol, Arachis hypogaea, triethyl citrate, tocopheryl acetate) or Necesse® Zinc Ointment (ingredients: petrolatum, Arachis hypogaea, zinc oxide, retinyl palmitate, tocopherol). Necesse® products are sold commercially by SCA Hygiene Products, Gothenburg, Sweden.

Other examples of some different skincare agents and/or substances that can be used with the invention are described partially inter alia in the following documents: WO 96/16682 “Diaper having a lotioned topsheet” (Roe et al.), WO 96/16681 “Diaper having a lotioned topsheet containing a polysiloxane emmollient” (Roe, Mackey), WO 97/05909 “Diaper having a lotioned topsheet comprising a liquid polyester emollient and an immobilizing agent” (Roe), WO 99/45973 “Disposable absorbent article having a skin care composition containing an enzyme inhibitor” (Roe et al.), WO 99/45974 “Protease inhibitors in absorbent products” (Rourke et al.), WO 99/45976 “Proton donating actives in absorbent articles” (McOsker et al.), DE 33 09 530 C1 “Hygienische Absorptionsvorlage” (Leitner et al.), DE 41 36 540 A1 “Einwegwindeln” (Grunecker et al.), U.S. Pat. No. 3,489,148 “Topsheet for disposable diapers” (Duncan et al.), WO 00/64502 “Absorbent article having a lotionized bodyside liner” (Krzysik et al.), WO 00/64501 “Skin-friendly absorbent articles and compositions” (Krzysik et al.), WO 00/64500 “Absorbent article having a hydrophilic lotionized bodyside liner” (Krzysik et al.), WO 00/64503 “Skin-friendly absorbent articles and compositions” (Krzysik et al.), WO 99/22684 “Web materials with two or more skin care compositions disposed thereon and articles made therefrom” (Roe et al.). Further examples of skincare agents within a lotion are published in WO 02/057546 and in WO 02/057547.

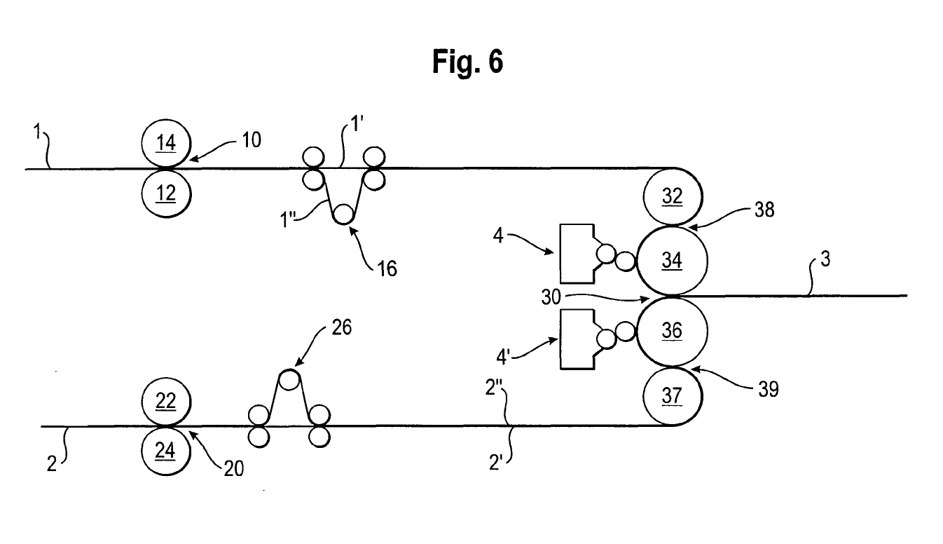

Turning back to FIG. 6, it shows yet another variant of the embodiments of FIGS. 4 and 5. Here, the upper web 1 as well as the lower web 2 comprise at least two separate plies 1′, 1″, 2′, 2″. At least two of the respective plies are fed through the first pre-embossing zone 10 or the second pre-embossing zone 20, the respective two plies 1′, 1″ or 2′, 2″ are then separated and displaced relative to each other by a separating and phase shifting means 16, 26 and are subsequently recombined. The separating and phase shifting means 16, 26 comprises at least one roll that causes one of the plies 1″ to exhibit a longer path length than that of the respective other ply 1′, 2′ . The two first plies 1′, 1″ are then recombined in the first décor embossing zone 38 and the two second plies 2′, 2″ are recombined in the second décor embossing zone 39. The resulting hygiene product 3 shows, again, increased bulk due to the fact that the embossed plies 1′, 1″, 2′, 2″ of the respective webs 1, 2 are not in register with each other any more.

In order to increase the strength of the bonding between the four plies of this embodiment, the second web 2 passes a second glue application unit 4′ which applies glue or an adhesive to the summit portions of the décor protrusions of the web 2. The glue application unit 4′ basically resembles glue application unit 4 that has been described above.

In this connection it is contemplated providing the steel roll 34 in the form of exchangeable sleeves. This may have the advantage of shortening the changeover-time when décor patterns are to be changed for a different product. It is also contemplated to provide the décor embossing roll 34, the steel lamination roll 36 and/or the respective counter rolls with cooling and/or heating means in order to be able to adjust the parameters of manufacturing process more precisely.

Even though FIGS. 1 to 6 show different embodiments of the method and the apparatus with which it can be effected, it is contemplated that the specific features of the embodiments can also be combined with one another in order to adopt the method and apparatus to specific manufacturing needs.

Furthermore, it will be appreciated that even though the embossing zones 10, 20, 33 are either referred to as “microstructure embossing zone” or “macrostructure embossing zone”, the respective embossing zones could likewise be a “macrostructure embossing zone” or a “microstructure embossing zone”, according to the manufacturing needs. It will be appreciated that the embodiments shown are intended solely to clarify the disclosure but are not to be construed limiting.

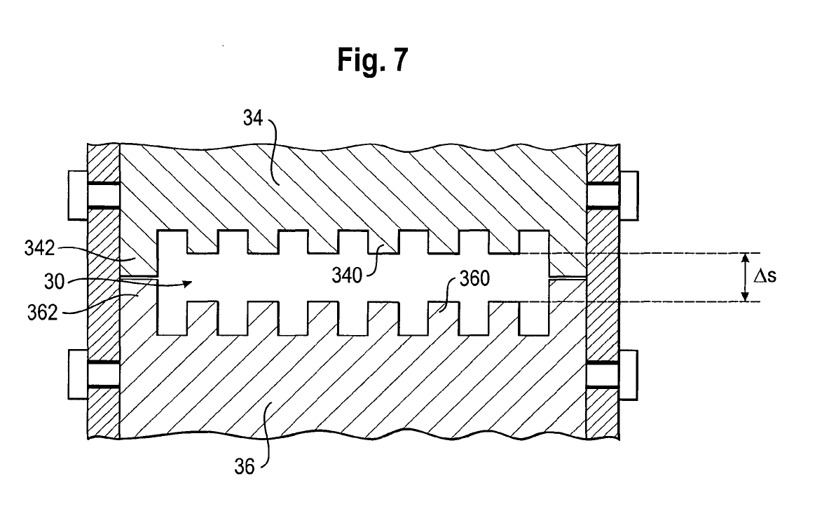

FIG. 7 illustrates a cross-section through the lamination zone 30 in a plane that includes the rotation axes of the décor embossing roll 34 and the lamination roll 36. The cross-section shows the spacing As between the highest extending protrusions 340, 360 of the both rolls. The cross-section, furthermore, shows the presence of Schmitz rings 342, 362 that are provided on both axially outer-most sides of the décor embossing roll 34 and the lamination roll 36. The Schmitz rings 342, 362 are basically smooth rings that are held in close contact to one another in order to provide defined and constant spacing As in the lamination zone 30. The overall spacing As of the lamination zone 30 between the décor embossing roll 34 and the lamination roll 36 is controlled to keep an overall spacing in a range of between 10 μm and 80 μm, preferably between 20 μm and 50 μm, more preferred between 20 μm and 35 μm. Preferably, this is accomplished by pressing the two rolls towards one another with a relatively high pressure such that they overcome any forces directed to separate the rolls that are exerted by the webs when they are feed through the lamination zone 30. Preferably, the rolls are pressed together such that the Schmitz rings 342, 362 are in constant contact.

FIG. 8 shows a cross-section through a sheet of a finished or a semi-finished hygiene product 3 according to a first embodiment. A first web 1 carries a décor embossing pattern with décor embossing protrusions 102 and a microstructure embossing pattern with microstructure protrusions 100. The first web 1 is bonded to a second web 2 in areas of the décor embossing protrusions 102 of the first web 1. The microstructure embossing pattern 100 has a lower height of its protrusions than the heights of the décor protrusions 102. In the shown embodiment, the second web 2 is not embossed. It is of particular interest that the second web 2 exhibits nearly no through-embossing in the areas 204 where the second web 2 is attached to the first web 1, namely in the areas of the décor protrusions 102 of the first web 1. In other words, the second web 2 is flat and extends in a single plane and does not show any considerable modulations in a direction perpendicular to that plane.

This particular property of the second web 2 is attributed to the method and arrangement described above in particular by the arrangement of the décor embossing roll 34 and the lamination roll 36 such that both have a generally equal surface hardness. In particular, this outcome can be attributed to the fact that the décor embossing roll 34 and the lamination roll 36 carry décor embossing patterns with décor embossing protrusions that are arranged and synchronized with each other in a tip-to-tip manner.

FIG. 9 shows a second embodiment in a cross-section through a sheet of a hygiene product 3 made from the first web 1 and the second web 2. The first web 1 carries microstructure protrusions 100 as well as décor protrusions 102. The second web 2 also carries a macrostructure pattern 200. Except in the area 204 in which the first web 1 and the second web 2 are attached to one another, there is no further modulation in the plane of the second web 2. In other words, besides the modulations of the macrostructure pattern 200, no other modulations are present in the second web 2. It can be seen, however, that in the area 204 of the second web 2 in which the second web 2 is attached to the first web 1, the macrostructure pattern 200 has been flattened during the lamination process in the lamination zone 30. However, the décor protrusions 102 of the first web 1 are not shown in the second web 2. Accordingly, a through-embossing in the sense that the second web is moved out of its plane perpendicularly in the direction towards the lower side of the lower web 2 in the area 204 is not present in the second web 2.

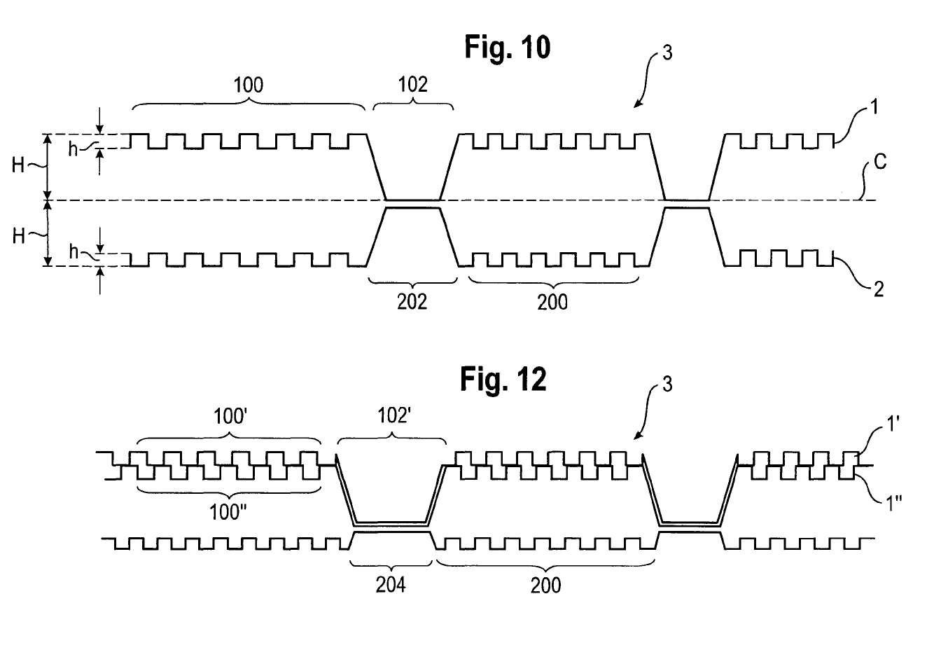

FIG. 10 shows another embodiment of a cross-section through a sheet of a hygiene product 3 in which the first web 1 and the second web 2 are décor embossed identically in a mirror-inverted manner. In other words, web 1 and web 2 show an identical décor structure but are mirror-inverted on a central plane C. This leads to a hygiene product 3 with almost perfect symmetry. The décor protrusions 102 of the first web 1 have a height H of approximately 0.8 to 5.0 mm, in particular 1.0 to 3.5 mm, more particular 1.2 to 3.0 mm. The microstructure embossing pattern 100 of the first web has a protrusion height h of less than that of the décor protrusions.

The décor protrusions 202 of the second web 2 are identical, but mirror inverted to the décor protrusions 102 of the first web 1. Furthermore, the second web 2 is microstructure embossed to carry a microstructure pattern 200 in the positions in which no décor embossing pattern is present. It will be appreciated that, as the hygiene product 3 has an almost perfectly symmetrical cross-section, the commonly used terms of the “inner side” and the “outer side” of the hygiene product relate to the position on a roll of a finally converted so-called finished hygiene product only. In particular, a difference of the sides cannot be experienced as soon as the hygiene product is unwound from its roll.

In this connection it is to be noted that the embossing patterns are preferably directed towards the inner side of the finished hygiene product in order to improve the smoothness of the product that can be experienced haptically on the outside of the product. In particular, the décor protrusions and the microstructure embossings are directed towards the inner side of the respective webs of the finished paper product in order to exhibit a smooth surface on the respective outsides of the product.

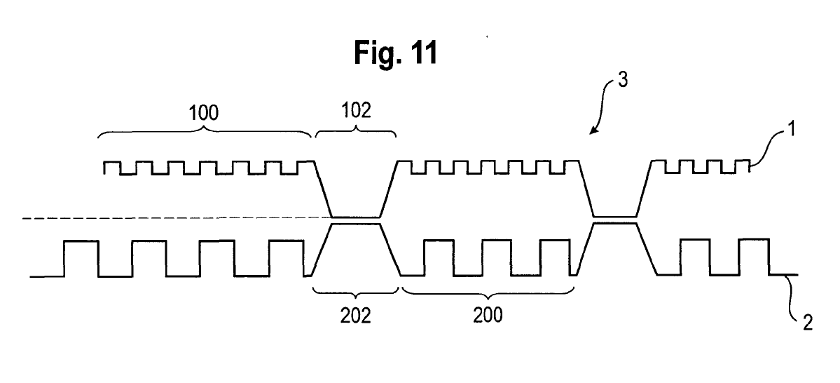

FIG. 11 is a cross-section through a sheet of a hygiene product 3 that basically shows the same structure of that shown in FIG. 10 with the exception that the first web 1 carries a microstructure embossing but the second web 2 carries a macrostructure embossing. Here, again, a perfectly symmetrical appearance of the décor protrusions 102, 202 can be seen but the upper and the under side of the hygiene product 3 differ as they are embossed with a different background pattern. Web 1 shows a microstructure pattern (100) and web 2 shows a macrostructure pattern (200).

FIG. 12 shows a cross-section of a further embodiment of a finished hygiene product 3 comprising a first web 1 of two first plies 1′, 1″ carrying a microstructure pattern 100′, 100″ and a décor protrusion pattern 102′. The microstructure patterns 100′, 100″ are shifted with respect to each other such that they are out of phase. This increases the bulk of the first ply 1.

The décor protrusions 102′ are in the same spot for both plies 1′, 1″ of the first web 1. The second web 2 also shows a microstructure embossing pattern 200 which is, in particular in the areas 204 in which the second ply 2 is attached to the first web 1, not moved out of the plane of the second web 2. However, in the areas 204 the microstructure embossing pattern 200 is flattened out. Nevertheless, there is a significantly reduced through-embossing or two-sidedness of the décor protrusions in the resulting hygiene product 3.

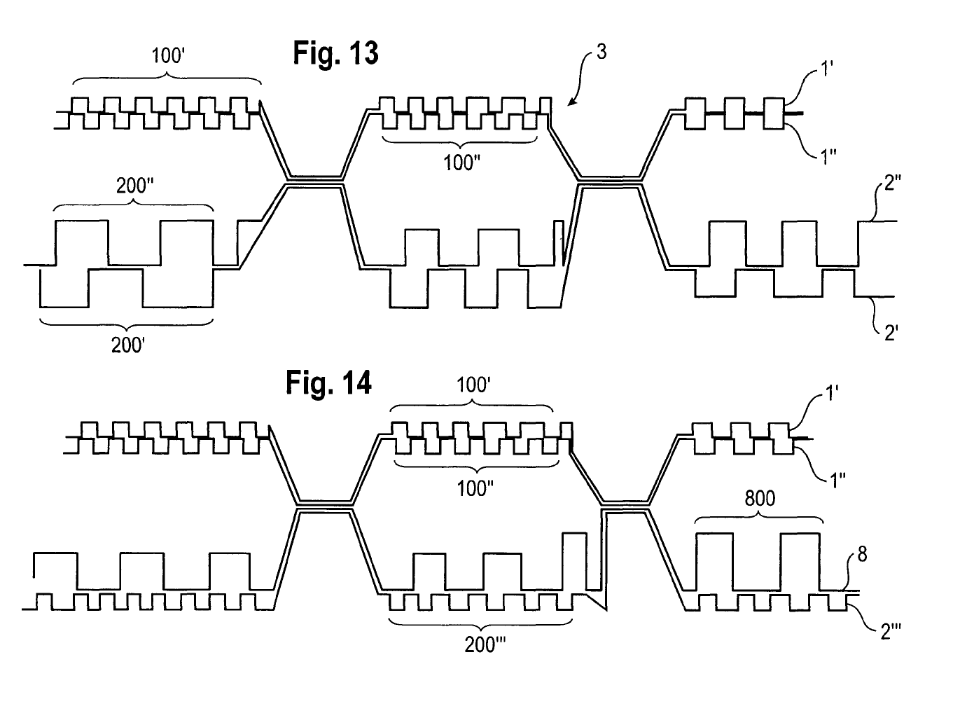

FIG. 13 shows another embodiment of a four-ply hygiene product 3 in a cross-section through a sheet of the hygiene product. The first web 1 has two first plies 1′, 1″ that carry microstructure patterns 100′, 100″ that are phase shifted with regard to each other, as has been explained with regard to FIG. 12. The web 2 has two second plies 2′, 2″ that carry macrostructure patterns 200′, 200″ that are phase shifted with regard to each other. This leads to a hygiene product showing increased bulk.

FIG. 14 shows yet another embodiment of a cross-section through a sheet of a hygiene product 3 in which the first plies 1′, 1″ of the first web 1 are basically arranged as in FIGS. 12 and 13. A second web 2′″ is provided on the intended lower side of the finished hygiene product 3 carries a microstructure embossing pattern 200′″ that is mirror-inverted with regard to the microstructure embossing patterns 100′, 100″ of the first plies 1′, 1″.

Between the first plies 1′, 1″ and the second web 2′″ there is provided a third ply 8 that carries a macrostructure embossing pattern 800. The third ply 8 is preferably embossed in a separate third embossing zone.

In this particular embodiment, the bulk of the finished paper product is increased but the two-sidedness can still be reduced or even avoided such that the hygiene product 3 has basically the same optical and haptic appearance on the upper side as on the lower side, in particular with regard to the décor protrusions.

In this connection it is contemplated using for the different plies different material qualities. In particular, it is contemplated using for the outer plies of the finished hygiene product different qualities than for the inner plies in order to increase bulk and absorption properties and to reduce material cost. In particular, for the inner plies recycled tissue paper could be used whereas for the outer plies, native fiber material could be used. Moreover, it is also possible to use plies having different colours.

1.-85. (canceled)

86. A method of manufacturing a hygiene product, which comprises:
providing at least a first web and a second web, the first web and/or the second web including at least one tissue paper ply;
pre-treating the first web and/or the second web by embossing at least a first microstructure pattern and/or a first macrostructure pattern therein before the respective webs enter a first décor embossing zone and/or a laminating zone;
embossing the first web with a décor embossing pattern in the first décor embossing zone comprising a décor embossing roll; and
laminating together the first web and the second web in a lamination zone defined between the décor embossing roll and a lamination roll, wherein the décor embossing roll and the lamination roll have a generally equal surface hardness,
wherein the lamination roll is arranged to carry décor embossing protrusions that define a décor embossing pattern that is mirror-inverted to the décor embossing pattern defined by the décor embossing protrusions of the décor embossing roll, and the décor embossing protrusions of the décor embossing roll and the décor embossing protrusions of the lamination roll define the lamination zone in a tip-to-tip manner.

87. A method for manufacturing a hygiene product, which comprises:
providing at least a first web and a second web;
embossing the first web with a décor embossing pattern in a first décor embossing zone comprising a décor embossing roll;
laminating together the first web and the second web in a lamination zone, the lamination zone being defined between the décor embossing roll and a lamination roll, wherein the distance between the décor embossing roll and the lamination roll in the lamination zone is controlled to keep an overall spacing (Δs) in a range of between 10 μm and 80 μm;
providing a Schmitz ring on the décor embossing roll and on the lamination roll; and
controlling the pressure exerted onto the webs such that the Schmitz rings generally remain in contact with one another.

88. The method according to claim 87, further comprising pre-treating the first web and/or the second web by embossing at least a first microstructure pattern and/or a first macrostructure pattern therein before the respective webs enter the first décor embossing zone and/or the laminating zone.

89. The method according to claim 87, wherein the lamination roll is arranged to carry décor embossing protrusions that define a décor embossing pattern that is mirror-inverted to the décor embossing pattern defined by the décor embossing protrusions of the décor embossing roll, and the décor embossing protrusions of the décor embossing roil and the décor embossing protrusions of the lamination roll define the lamination zone in a tip-to-tip manner.

90. The method according to claim 87, wherein the décor embossing roll and the lamination roll have a generally equal surface hardness.

91. The method according to claim 87, wherein the first décor embossing zone is arranged to be formed by the décor embossing roll and a first counter roll, the first counter roll having a surface hardness less than that of the décor embossing roll.

92. The method according to claim 87, further comprising embossing the second web with a décor embossing in a second décor embossing zone, the second décor embossing zone being defined between said lamination roll and a second counter roll, whereas the second counter roll has a surface hardness less than that of the lamination roll.

93. The method according to claim 87, further comprising pre-treating the first web and/or second web in a first pre-embossing zone before the first web and/or second web enters the lamination zone by embossing a first microstructure pattern and/or macrostructure pattern into the respective web, and/or comprising the step pre-treating the second web and/or first web in a second pre-embossing zone before the second web and/or first web enters the lamination zone by embossing a second microstructure pattern and/or macrostructure pattern into the respective web.

94. The method according to claim 88, wherein the microstructure pattern comprises microstructure protrusions that are chosen to exhibit a protrusion density between 25 to 120 dots/cm², and/or the microstructure pattern is embossed in an embossing zone with a microstructure embossing roll comprising microstructure pattern protrusions that are chosen to be of a height of 0.3 to 1.0 mm, and/or the macrostructure pattern comprises macrostructure protrusions that are chosen to exhibit a protrusion density below 25 dots/cm², and/or the macrostructure pattern is embossed in an embossing zone with a macrostructure embossing roll comprising macrostructure pattern protrusions that are chosen to be of a height of 0.3 to 5.0 mm, and/or the décor embossing roll comprises décor pattern protrusions that are chosen to be of a height of 0.3 to 5.0 mm.

95. The method according to claim 87 further comprising applying glue to at least one of the webs using a glue application unit before the webs enter the lamination zone.

96. The method according to claim 87, wherein the décor embossing roll comprises décor pattern protrusions that are set to exhibit at least a first height and microstructure pattern protrusions and/or macrostructure pattern protrusions that are set to exhibit at least a second height, the second height being lower than the first height, and/or the lamination roll comprises décor pattern protrusions that are set to exhibit a third height and microstructure protrusions and/or macrostructure protrusions that are set to exhibit a fourth height, the fourth height being equal to or smaller than the third height.

97. The method according to claim 87, wherein at least one additional web, comprising one or two additional plies is fed through the lamination zone together with the first and the second web, said additional web being pre-treated by embossing a microstructure pattern and/or a macrostructure pattern therein.

98. An apparatus for manufacturing a hygiene product, comprising:
a lamination zone being formed by a décor embossing roll and a lamination roll, the décor embossing roll and the lamination roll having a generally equal surface hardness;
a first décor embossing zone, the décor embossing zone being located upstream of the lamination zone and being defined between the décor embossing roll and a first counter roll; and
at least one pre-treating device located upstream both of the lamination zone and the décor embossing zone, the pre-treating device being arranged to pre-treat at least one web,
the pre-treating device comprising an embossing zone for embossing a microstructure pattern and/or a macrostructure pattern into a web, and wherein the lamination roll carries an embossing pattern that is mirror-inverted to that of the décor embossing roll, and the décor embossing roll and the lamination roll form the lamination zone in a tip-to-tip manner.

99. The apparatus according to claim 98, wherein a second décor embossing zone for embossing a second web with a décor embossing is formed by said lamination roll and a second counter roll, the second counter roll having a surface hardness less than that of the lamination roll, and/or a second micro-embossing zone for pre-embossing a second microstructure and/or macrostructure pattern in the second web and/or first web being provided before the second web and/or first web enters the lamination zone.

100. The apparatus according to claim 98, wherein a controller for controlling the distance between the décor embossing roll and the lamination roll in the lamination zone is provided to keep an overall spacing (Δs) in a range of between 10 μm and 80 μm, in the form of a Schmitz ring on the décor embossing roll and on the lamination roll such that the pressure exerted onto the webs is controlled such that the Schmitz rings generally remain in contact with one another.

101. A multi-ply hygiene product, comprising:
at least a first web carrying a microstructure pattern and/or a macrostructure pattern, and a décor embossing pattern comprising décor embossing protrusions; and
at least a second web, the first web and the second web being bonded to one another in the summit areas of the décor embossing protrusions of the first web.

102. The multi-ply hygiene product according to claim 101, wherein the second web comprises a microstructure pattern and/or a macrostructure pattern.

103. The multi-ply hygiene product according to claim 101, wherein the second web is substantially flat.

104. The multi-ply hygiene product according to claim 101, wherein the hygiene product is a toilet paper.

105. The multi-ply hygiene product according to claim 101, wherein the hygiene product is a facial paper.
